(19) United States
(12) Patent Application Publication
(10) Pub. No.: US 2026/0104065 A1
(43) Pub. Date: Apr. 16, 2026

(54) SHEET-BASED FLUIDIC DIODES FOR EMBEDDED FLUIDIC CIRCUITRY IN SOFT DEVICES

(71) Applicant: William Marsh Rice University, Houston, TX (US)

(72) Inventors: Daniel J. Preston, Houston, TX (US); Vi T. Vo, Houston, TX (US); Anoop Rajappan, Houston, TX (US); Barclay Jumet, Houston, TX (US); Marquise D. Bell, Houston, TX (US); Sofia Urbina, Houston, TX (US)

(73) Assignee: William Marsh Rice University, Houston, TX (US)

(21) Appl. No.: 19/354,795

(22) Filed: Oct. 9, 2025

Related U.S. Application Data
(60) Provisional application No. 63/705,881, filed on Oct. 10, 2024.

(51) Int. Cl. F15C 3/00

(52) U.S. Cl. CPC F15C 3/00

(57) ABSTRACT

An apparatus and system are disclosed. The apparatus includes a first deformable conduit, including a passive self-pinching fluidic channel having an unsealed free first end and a first connecting port at a second end of the first deformable conduit, and a second deformable conduit, comprising an inflatable fluidic channel with a sealing first end, configured to enclose at least a portion of the passive self-pinching fluidic channel and to form a seal between an inner surface of the inflatable fluidic channel and an outer surface of the passive self-pinching fluidic channel, and a second connecting port at a second end of the second deformable conduit. Furthermore, the first deformable conduit contains a fluid at a first pressure, and the second deformable conduit contains the fluid at a second pressure.

### CROSS REFERENCE TO RELATED APPLICATIONS

This application claims priority to U.S. Provisional Application No. 63/705,881 which is hereby incorporated by reference into the instant application.

### STATEMENT REGARDING FEDERALLY SPONSORED RESEARCH

This invention was made with government support under Grant No. 80NSSC21K1276, awarded by NASA, and Grant No. CMMI-2144809 and Grant No. 1842494 both awarded by the National Science Foundation. The government has certain rights in the invention.

### BACKGROUND

Pressure-driven soft robots have emerged as a promising approach to enable the complex interactions required in unstructured and dynamic environments. These robots often utilize integrated, flexible actuators controlled by the inflation and deflation of internal channels or bladders with pressurized fluid, resulting in deformable structures useful for tasks requiring adaptability and compliance. The internal pressure of these structures can be varied to achieve complex and adaptive motions through nonlinear deformations that can be difficult to achieve with rigid components. The practical implementation of these pneumatic soft robots, however, still faces two main challenges. First, the demand for a number of control signal inputs increases proportionally with the number of independent soft actuators due to a lack of embedded control and second, the reliance on rigid and bulky electronic control systems and hard electromechanical valves results in increased complexity (i.e., interfacing electrical and fluidic systems) and weight while limiting deformability. Consequently, a means to overcome these limitations forms a pressing need.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to an apparatus a first deformable conduit, including a passive self-pinching fluidic channel having an unsealed free first end, and a second deformable conduit, comprising an inflatable fluidic channel with a sealing first end, configured to enclose at least a portion of the passive self-pinching fluidic channel and to form a seal between an inner surface of the inflatable fluidic channel and an outer surface of the passive self-pinching fluidic channel where the first deformable conduit contains a fluid at a first pressure, and the second deformable conduit contains the fluid at a second pressure.

Further, the apparatus may optionally include a first connecting port at a second end of the first deformable conduit and a second and a second connecting port at a second end of the second deformable conduit. The first connecting port and the second connecting port may comprise pneumatic connectors.

Further, the second deformable conduit of the apparatus may optionally include a first hermetically sealable textile sheet; and a second hermetically sealable textile sheet, wherein each of two opposing edges of the first hermetically sealable textile sheet is hermetically sealed to one of two opposing edges of the second hermetically sealable textile sheet. Still further, the first hermetically sealable textile sheet and the second hermetically sealable textile sheet be made from a thermoplastic-coated textile.

Optionally, wherein the passive self-pinching fluidic channel having the unsealed free first end is configured to collapse forming a seal when the second pressure is greater than the first pressure, and/or the passive self-pinching fluidic channel having the unsealed free first end is configured to flow the fluid from the passive self-pinching fluidic channel into the second deformable conduit when the first pressure is greater than the second pressure. Also, optionally, the fluid comprises a carbon dioxide gas.

Still further, optionally, the apparatus may include a tread-activated bellows (i.e., a bellows that is activated by a foot applying a stepping force, for example, while walking) having an output fluid channel; and a textile storage pouch forming an input channel, where the output fluid conduit of the tread-activated bellows is connected to the second end of the first deformable conduit, and the input channel of the textile storage pouch is connected to the second connecting port of the second deformable conduit.

In general, in one aspect, embodiments relate to a flexible fluid logic gate, including a plurality of flexible fluidic diodes, wherein each of the plurality includes a first deformable conduit, comprising a passive self-pinching fluidic channel having an unsealed free first end, and a second deformable conduit, including an inflatable fluidic channel with a sealing end, configured to enclose at least a portion of the passive self-pinching fluidic channel and to form a seal between an inner surface of the inflatable fluidic channel and an outer surface of the passive self-pinching fluidic channel, and at least one flexible fluidic resistor. Further, the first deformable conduit contains a fluid at a first pressure, and the second deformable conduit contains the fluid at a second pressure.

Further, the plurality of flexible fluidic diodes and the at least one flexible fluidic resistor in the flexible fluidic logic gate may optionally be configured to form a logical OR-gate and/or a logical AND-gate.

In addition, the second deformable conduit of the flexible fluidic logic gate may optionally include a first hermetically sealable textile sheet, and a second hermetically sealable textile sheet, with each of two opposing edges of the first hermetically sealable textile sheet hermetically sealed to one of two opposing edges of the second hermetically sealable textile sheet. Further, the first hermetically sealable textile sheet and the second hermetically sealable textile sheet may be formed from a thermoplastic-coated textile.

Still further, the passive self-pinching fluidic channel having the unsealed free first end may optionally be configured to collapse forming a seal when the second pressure is greater than the first pressure and/or at least one flexible fluidic resistor is formed from a thin serpentine-path channel.

Still further, the flexible fluidic logic gate may be included in a flexible binary fluidic encoder. The flexible binary fluidic encoder may be an n-bit flexible binary fluidic encoder that includes a plurality n of flexible fluidic resistors.

In general, in one aspect, embodiments of the n-bit flexible binary fluidic encoder relate to a flexible 3-bit fluidic encoder, including three individual flexible fluidic diodes, where each of the three individual flexible fluidic diodes are connected to one input fluid conduit; three pairs of flexible fluidic diodes, where in each of the three pairs of flexible fluidic diodes are connected to one input fluid conduit; one triplet of flexible fluidic diodes, where the triplet of flexible fluidic diodes is connected to one input fluid conduit; and three fluidic resistors.

The first fluidic resistor may be connected to a first fluid conduit, a second fluidic resistor may be connected to a second fluid conduit, and a third fluidic resistor may be connected to a third fluid conduit. Further, an output of a first individual flexible fluidic diode may be connected to the first fluid conduit, an output of a second individual flexible fluidic diode may be connected to the second fluid conduit, an output of a third individual flexible fluidic diode may be connected to the third fluid conduit, a first output of a first pair of flexible fluidic diodes may be connected to the first fluid output conduit, a second output of the first pair of flexible fluidic diodes may be connected to the third fluid output conduit, a first output of a second pair of flexible fluidic diodes may be connected to the first fluid output conduit, a second output of the second pair of flexible fluidic diodes may be connected to the second fluid output conduit, a first output of a third pair of flexible fluidic diodes may be connected to the second fluid output conduit, and a second output of the third pair of flexible fluidic diodes may be connected to the third fluid output conduit. Still further a first output of the triplet of flexible fluidic diodes may be connected to the first output conduit, a second output of the triplet of flexible fluidic diodes may be connected to the second output conduit, and a third output of the triplet of flexible fluidic diodes may be connected to the third output conduit.

Optionally, the passive self-pinching fluidic channel of the flexible 3-bit fluidic encoder, having the unsealed free first end is configured to collapse forming a seal when the second pressure is greater than the first pressure.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIGS. 1A-1C show sheet-based fluidic diodes in accordance with one or more embodiments;

FIGS. 2A-2D display schematics and experimental data showing the fluidic characteristics of sheet-based fluidic diodes in accordance with one or more embodiments;

FIG. 3 depicts results for a self-sealing device in accordance with one or more embodiments;

FIGS. 4A-4B depicts diode logic gates in accordance with one or more embodiments;

FIG. 5 depicts cascaded logic gates in accordance with one or more embodiments;

FIGS. 6A-6B depict a fluidic encoder in accordance with one or more embodiments;

FIG. 7 depicts the fabrication of a fluidic diode in accordance with one or more embodiments;

FIG. 8 depicts a characterization of the forward flow across the inner valve of the fluidic diode in accordance with one or more embodiments;

FIG. 9 depicts a schematics of an electropneumatic circuit used to experimentally obtain the transient response of logic gates in accordance with one or more embodiments;

FIGS. 10A-10B depict characterization of the performance of cascading AND-gates in accordance with one or more embodiments;

FIG. 11 shows a schematic of an electropneumatic circuit for characterization of the 3-bit encoder in accordance with one or more embodiments;

FIG. 12 depicts preparation of textile layers used for layered fabrication of a single fluidic diode in accordance with one or more embodiments;

FIG. 13A depicts preparation of textile layers used for layered fabrication of 3-bit encoder in accordance with one or more embodiments;

FIG. 13B depicts the output channel layer of the 3-bit encoder in accordance with one or more embodiments;

FIG. 14 depicts a flexible fluidic diode in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

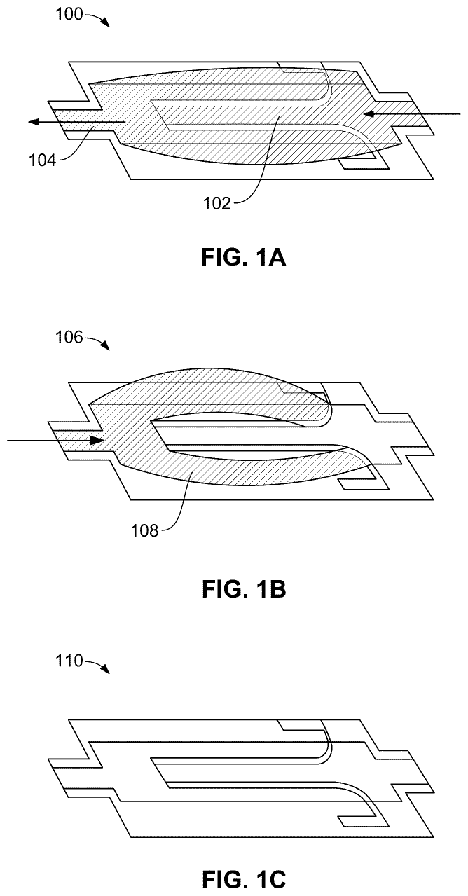

In the following description of FIGS. 1-14, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a fluidic diode” includes reference to one or more of such fluidic diodes.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

The present disclosure provides an embodiment of a fluidic device: a sheet-based fluidic diode (i.e., a valve that permits flow in only one direction) that is constructed using flexible sheet-like materials, such as polymer sheets or fabrics, using a layered fabrication approach amenable to manufacturing at scale. These sheet-based fluidic diodes restrict reverse flow over a wide range of pressure differentials and exhibit a diodicity (the ratio of resistance to reverse versus forward flow) of approximately 100, thereby addressing functional limitations of prior soft fluidic diodes. By harnessing the disclosed diode's highly unidirectional flow, soft devices capable of (i) capturing pressurized air for storage, (ii) performing Boolean operations using diode logic, (iii) enabling binary encoding of circuits by preventing interactions between different pressurized input lines, and (iv) rectifying oscillating input pressures to a direct-current-like, positively phased output, are realized. These applications exemplify the use of fluidic diodes to achieve embedded fluidic control and signal processing, enabling future development of complex and capable soft sheet-based systems—including wearable and assistive robots made from textiles—as well as other soft robotic devices.

The disclosed sheet-based fluidic diodes address pragmatic limitations in the current state of the art. Prior fluidic diodes have been bulky, rigid, and unamenable to the wearable or packable nature for which soft robotics is often lauded. Because the disclosed sheet-based fluidic diodes are completely pliable, low-cost, and scalable (in size and manufacturing), there are a wide range of applications. These diodes can be used to create self-sealing balloons, which simplify the process of inflating and sealing balloons without manual tying; they can be integrated into inflatable car jacks, providing a lightweight, portable, and reliable solution for lifting vehicles during tire changes or maintenance, which can be particularly useful for emergency roadside kits; the diodes also enable energy-harvesting insoles that convert the pressure from walking into stored energy, which can be used to power small wearable devices, enabling a self-powered system.

Furthermore, these diodes may find use in inflatable structures in remote or low-resource environments where weight, cost, and condensability (packing) are substantial considerations. Moreover, because these diodes represent the fluidic analog of electronic diodes—an integral component in modern-day computing—this technology could similarly lead to the development of highly sophisticated soft robotic systems, capable of adapting within, responding to, and interacting with their environment, enhancing applications in wearable and non-wearable healthcare, personal assistance, and beyond.

The diodes described herein, in accordance with one or more embodiments, both (a) use fluids rather than electronics and (b) are entirely made from soft sheet-based materials. The softness of the disclosed sheet-based design enables an improvement in diodicity over the state of the art, with the fully soft diodes disclosed herein demonstrating a ratio of forward to reverse flow of 100.

The disclosed diode may be made from a wide array of sheet materials (for example, textile, polyurethane, and nylon). The disclosed diode is widely applicable due to the ability to design and scale the device to particular applications, such as designing a diode capable of incorporation into high-force, high-pressure systems like lifting a car off the ground or high-cycle systems where mechanical fatigue is a concern. While many sheet-based goods, particularly wearable ones, are assembled with sewing techniques, the disclosed device uses a heat-sealing technique (stacked lamination) that is widely employed in the apparel and soft goods industries (outdoor or camping accessories, medical devices, etc.). Though fluidic computation is generally slower than electronic computation (where the lower limits of response time are orders of magnitude apart), the simple methods of integration in this work—that is, fluidic circuits with few subcomponents and low levels of complexity—make possible response times that are minimally impactful to the usability of the device.

Soft fluidic analogs to electrical components aim to reduce the demand for rigid and bulky electromechanical valves and hard electronic controllers within soft robots. Described herein are systems and methods for creating sheet-based fluidic diodes constructed from readily available flexible sheets of polymers and textiles using a layered fabrication approach amenable to manufacturing at scale. These sheet-based fluidic diodes restrict reverse fluid flow over a wide range of differential fluid pressures to address functional limitations exhibited by prior soft fluidic diodes. By harnessing the diode's highly unidirectional flow, soft devices capable of facilitating the capture and storage of pressurized fluid, such as nitrogen or carbon dioxide gas, performing Boolean operations using diode logic, enabling binary encoding of circuits by preventing interactions between different pressurized input lines, and converting oscillating input pressures to a direct current-like, positively phased output may be realized. This work exemplifies the use of fluidic diodes to achieve complex patterns of actuation and unique capabilities through embedded fluidic circuitry, enabling future development of sheet-based systems—including wearable and assistive robots made from textiles—as well as other soft robotic devices.

Fluidic computing, or the manipulation of pressurized fluids to perform computational tasks, introduces an alternative approach enabling electronics-free control systems for pneumatic soft robots. Instead of relying on traditional electronic components, fluidic logic gates and circuits can be embedded within a robot's structure to program sequential actions and control its movement in response to stimuli. While microfluidic devices have shown potential in achieving precise and intricate control in applications such as lab-on-a-chip and bioinspired microrobotics, these systems are often not practical for mesoscale robotics applications due to challenges in scaling that arise from fluid pressure requirements (smaller fluidic channels require greater pressures to drive fluid flow or remain limited to lower flow rates), fabrication processes (microfluidic processes typically use soft lithographic approaches that may not translate to the mesoscale easily), and material compatibility (microfluidic systems have typically included glass or silicon, which compromise a soft construction).

Alternatively, recently developed mesoscale soft fluidic circuits use compliant materials to create devices for robotic control, with individual components documented in prior work successfully demonstrating functionalities analogous to electronic counterparts. Among these soft fluidic components, soft fluidic diodes (e.g., one-way valves or check valves) are essentially unexplored despite their distinct functionality. Furthermore, existing soft fluidic diodes exhibit limitations including bulky 3D architectures, which impose functional limitations for robots navigating in space-constricted or resource-constrained environments, and suboptimal performance, primarily concerning the required closing pressure before fully restricting backflow.

Herein, a sheet-based fluidic diode is disclosed that passively restricts backflow by collapsing an internal channel, as shown in FIGS. 1A-1C. Following a general trend in soft robotics toward implementation of flexible, sheet-based materials (e.g., acetate, paper, and textiles) due to the lightweight and low-profile designs they enable, the disclosed sheet-based diode is composed of commercially available sheet materials including heat-sealable textiles and thermoplastic films that are assembled using a scalable process of thermal lamination. Thus, the sheet-based fluid diode may include a thermoplastic-coated textile. The textiles used for the disclosed sheet-based diode fabrication may be hermetically sealable textile sheets through which no fluid, including no air or gas, can escape.

To understand the flow behavior of the diode, and to guide future circuit design, the circuit was characterized using the fluidic resistance (i.e., the relationship between the volumetric flow rate and the differential fluid pressure across the diode) and a scaling law relating fluidic resistance to diode size developed. The demonstrated functionalities enabled by the sheet-based diodes include: (a) capturing and storing pressurized air when coupled with pneumatic pouches (i.e., fluidic capacitors analogous to electrical capacitors), as exemplified in practical applications of a self-sealing balloon and an inflatable car jack; (b) making decisions with diodes arranged as logic gates that use levels of fluid pressure, such as air, nitrogen, or carbon dioxide, to perform computations; (c) facilitating the routing of fluid along designated pathways, exemplified by a fluidic encoder generating binary indices (i.e., a flexible binary fluidic encoder); and (c) rectifying air-flow by converting oscillating fluid pressure inputs to a positive-phase, direct current (DC)-like output fluid pressure, demonstrated by integrating the diodes into a textile-based energy harvesting system that can extract pneumatic energy from walking. These sheet-based fluidic diodes represent fundamental mechano-fluidic computing elements that enable embedded, multifunctional circuits for programmable control of pneumatically actuated robots.

FIGS. 1A-1C show the operation of the diode. In FIG. 1A, the forward mode 100 is shown in which air flows through the internal channel 102 and exhausts at the outlet port 104. In FIG. 1B, the reverse mode 106 is shown in which air fills the internal volume 108 of the encasing pouch, resulting in a compressive force that pinches the internal channel closed and prevents air from flowing, even for vanishingly small pressure differences in the reverse flow direction because the requisite pressure drop corresponding to any level of flow through the internal channel would result in a lower pressure within the flow channel than in the surrounding pouch. In FIG. 1C, the deflated diode 110 is shown.

The disclosed sheet-based diode consists of two main functional features: (a) a duckbill-like channel connected to the inlet port that flows into (b) an encasing chamber surrounding the channel. The operating principle of the diode draws inspiration from microfluidic pinch valves: as pressurized air accumulates inside the encasing chamber it exerts a compressive force on the channel that pinches the walls together, sealing the valve against flow. The design of the inner duckbill channel may be critical. After testing various geometries and ratios of width to length, it was found that the inner duckbill channel effectively restricts flow at an aspect ratio of 0.0974 (“1.00” scale has a width of 3.0 mm and a length of ≈30.8 mm). Such a design achieves flow polarity based on a 2D architecture, differentiating it from previous designs of fluidic diodes that either use 3D elastomeric materials (e.g., rubber flaps, O-rings, and elastic membranes) or rely on rigid materials (e.g., acrylic or 3D-printed pieces) to form the physical barrier blocking flow.

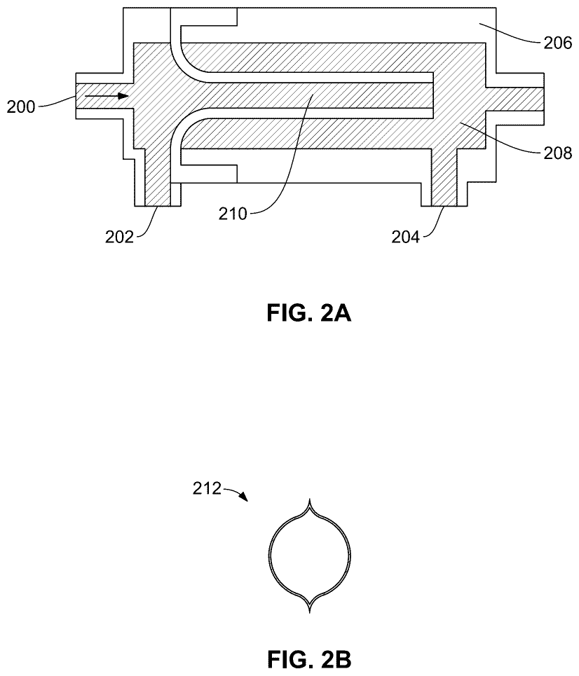

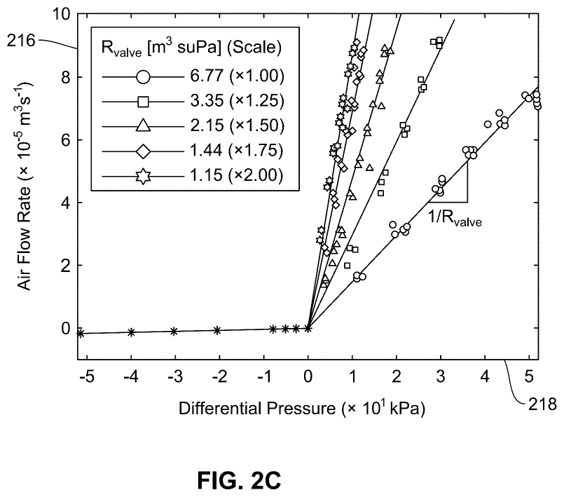

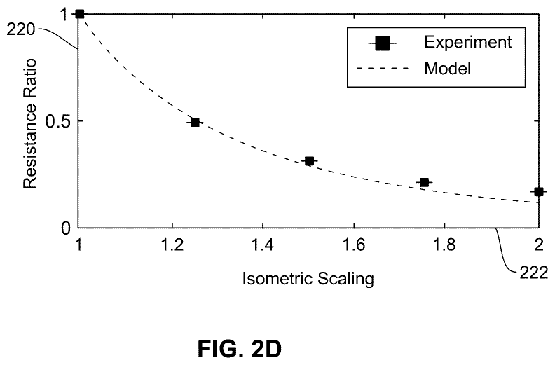

FIGS. 2A-2C displays schematics and experimental data showing characteristics of a fluidic diode in accordance with one or more embodiments.

FIG. 2A depicts a pneumatic testbed for testing the flow behavior of a sheet based fluidic diode. The pneumatic testbed has a pressure supply 200, pressure inlet port 202, and pressure outlet port 204. The pressure inlet port 202 and pressure outlet port 204 enable measurement of differential pressure across the diode, eliminating the effects of the fluidic connections at the inlet and outlet. The pneumatic testbed has inflated flow channels 208 defined by bonded areas 206 (e.g., TPU-bonded areas). Pressure from the pressure supply 200 inflates the inflated flow channels 208, including the internal duckbill channel 210 which has a width w and a length 1.

FIG. 2B depicts cross section 212 of the internal duckbill channel 210 in the experimental testbed. In accordance with one or more embodiments, the cross section 212 has a width of 2π divided by the width w of the internal duckbill channel 210. The cross-sectional width may be used to derive the theoretical model of the fluidic resistance as a function of isometric scaling in accordance with one or more embodiments. If the pneumatic testbed was represented as a circuit diagram, the pressure supply 200 would be in series with resistors. For example, one or more needles and valves may provide fluidic resistance in the pneumatic testbed.

FIG. 2C shows experimental results for fluid flow (plotted on the x-axis 218) versus differential pressure (plotted on the y-axis 216) for the fluidic diode. The flow behavior of the fluidic diode may be characterized by plotting the flow rate as a function of the differential pressure across the diode. From the experimental data, two distinct operating regimes were observed based on the polarity of the differential pressure, indicating that the fluidic diode exhibits performance analogous to that of an electronic diode. In the forward direction (i.e., differential pressure greater than 0 kPa), increasing differential pressures result in linearly increasing flow rates. In the reverse direction (i.e., differential pressure less than 0 kPa), the flow rate remains at or near 0 m³ s⁻¹ indicating not only the prevention of backflow but also the absence of a minimum pressure required to close the valve in the reverse flow—a constraint that arises due to the geometry or material properties of the sealing mechanism responsible for restricting flow.

To quantitatively determine the fluidic resistance across the valve, the design of the device may include two ports directly before the entrance and after the exit of the internal duckbill channel (see FIG. 2A), which allows measurement of differential pressure across the diode without accounting for the resistances of the fluidic connections. The “diodicity” (i.e., the ratio of flow resistances for reverse vs forward flow, which are inversely proportional to the slopes in FIG. 2C) was found to be approximately 100, indicating sufficient performance for most fluidic applications. Meanwhile, for forward flow, it was determined that the fluidic resistance, the Rᵥₐₗᵤₑ, of the diode is inversely proportional to the length scale of the diode raised to the third power (i.e., cubed), following the expected isometric scaling relationship. The linear relationship observed from the lines in FIG. 2C suggests that the flow across the internal duckbill channel 210 is within the laminar regime.

FIG. 2D shows the effect of isometric scaling (plotted on the x-axis 222) on the resistance ratio (plotted on the y-axis 220) for forward flow (i.e., compared to the times 1.00 scale). Experimental data is plotted alongside model predictions, and error bars on the experimental data correspond to the standard deviation across three trials. Slight deviations were observed between the model curve and measured data as the length scale increases, potentially indicating entry into the turbulent flow regime. The predictability of the diode's performance based on this analysis is limited to specified flow rates and length scales corresponding to laminar flow in accordance with one or more embodiments. In one or more other embodiments, the predictability of the diode's performance could be extended to turbulent flow either empirically or through more detailed modeling.

Fluidic diodes allow for energy storage when coupled with a pneumatic pouch or other known volume (i.e., a fluidic component analogous to an electronic capacitor). For a system subjected to a momentary or static fluidic input signal (e.g., a constant high-pressure input), this configuration facilitates the capture and storage of pressurized fluid by allowing fluid to enter and accumulate within the capacitor while limiting backflow of the fluid when the high-pressure source is removed, ensuring a stable pressurized environment with near-negligible deflation. The diode is capable of maintaining pressure in a variety of applications, such as a self-sealing balloon and an inflatable car jack.

A self-sealing mylar balloon may be created, for example, using two-dimensional (2D) fabrication techniques and thick nylon film as the substrate. A heat-sealing process may be used to bond layers of nylon film using a thick TPU film. These materials may be selected for their low sheet density, which may increase the net buoyancy of the resulting balloon. Due to the high heat resistance of the nylon film (i.e., the layer melts and bonds at a higher temperature), the TPU film may act as an adhesive layer that thermally bonds two nylon layers.

More generally, a typical mylar balloon contains four gores (i.e., narrow vertical segments forming the shape of the balloon) to achieve a quasi-spherical volume when inflated. In accordance with one or more embodiments, a fluidic diode may be fabricated from a layered fabrication of Stretchlon 800 (i.e., vacuum bagging nylon film) and Riverseal Film T150 (i.e., a monolithic TPU film). Sheet layers may be used to fabricate the inner valve and the entire fluidic diode. A vinyl cutter patterns each layer in one pass. Layers of Riverseal Film T150 may define the bonding region of the device due to its lower melting temperature. Thus, in contrast to the nylon taffeta version of a fluidic diode disclosed herein, the pattern of the internal geometry is generated by subtracting the outer geometry by the internal geometry (i.e., the area that will form the inflated volume when actuated). The layers may then be heat pressed together at 185° C. with a platen pressure of 20 kPa.

In this example of a self-sealing mylar balloon, the balloon may include a pressure-release valve and a fluidic diode. The pressure-release valve may be located at the tip of the balloon opposite the filling port to allow for repeated use, and the fluidic diode may be attached at the inflating port used to supply gas (e.g., helium) into the balloon. The fluidic diode may provide a method of sealing after inflation that mitigates (but does not completely prevent) escape of helium from the balloon. The fluidic diode may offer a convenient solution to the challenges posed by the manual process of tying knots or using external ties and clips to seal balloons after inflation, a feature particularly useful for those with limited dexterity. The pressure-release valve may be optional for commercial use.

To operate the balloon, the balloon may be filled with helium gas via a dispensing needle connected to a helium tank until it is full. Balloon fullness may be determined, for example, by visually inspecting that the material appears taut, and the shape of the balloon is sufficiently round. Then, the helium supply may be cut off and the needle removed from the inlet of the balloon. Next, the balloon may be held for ≈5 s, without pressure exerted on the inlet channel, and finally allowed to ascend.

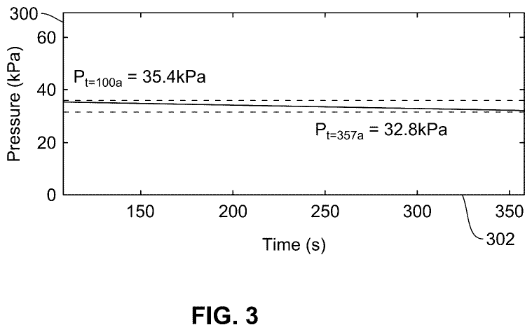

As another example, a self-sealing inflatable car jack may be made using a fluidic diode in accordance with one or more embodiments. The car jack may sustain a large, pressurized volume for a sufficient duration of time to support part of a vehicle. FIG. 3, for example, is a pressure plot for a self-sealing inflatable car jack as it supports the front axle of a 2022 Volkswagen Tiguan (≈1750 kg). The pressure is plotted along the y-axis 300 and the time is plotted along the x-axis 302. The plot illustrates the near-negligible loss of pressure starting from when the air compressor is disconnected from the inlet of the diode to when the diode is disconnected from the coupler.

The inflatable car jack may include, for example, a quick-connect connection between an air compressor and the reverse inlet of a fluidic diode. A second quick-connect connection may be placed between the forward inlet of the fluidic diode and an inflatable carjack. Flexible tubing may be epoxied to the inlet of the diode to prevent kinking during inflation. Additionally, a coupler may be 3D printed to create a connection between the second quick-connect connection and the inflatable carjack. Within the car jack, a pressure loss of approximately 12.7% was observed over 10 minutes. Continuous pressure measurements of the system were taken over a duration of approximately 18 minutes. A system pressure loss of 9.8% was observed in the controlled experiment in which the supply was connected directly to the portable air tank and then disconnected (corresponding to the leak rate of the other fittings used in the experiment). A system pressure loss of 17.2% was observed with the diode connected to the portable air tank.

Inflatable car jacks are valuable tools for lifting vehicles by providing a secure placement beneath various sections of the vehicle regardless of the terrain and are often compatible with portable air compressors (or even the pressure generated by a car's exhaust) to provide swift and efficient lifting support. Although offroad inflatable car jacks come with exhaust jacks or filler tubes featuring integrated one-way valves, these components typically consist of inflexible and relatively heavy materials such as hard plastics or stainless steel, and they can fail or break if the car jack inflates in an incorrect configuration and presses them against the undercarriage. The potential of the sheet-based fluidic diode to achieve comparable prevention of backflow to valves included in standard car jack kits was investigated. The planar design of the sheet-based fluidic diode is consistent with the sheet-based structure of most inflatable car jacks which may enable monolithic fabrication. Specifically, a commercially available inflatable car jack was retrofitted with an adapter affixed to the rubber interface of the filling port and an air compressor connected to the car jack using a fluidic diode fabricated from nylon taffeta. To initiate the lifting operation, the deflated car jack was positioned beneath the front of a vehicle directly below the car's chassis. By gradually increasing the pressure of the air compressor from 0 to 410 kPa, the car jack was inflated until the front tires lifted off the ground. After lowering the air supply to 0 kPa and disconnecting the coupler connected to the compressor, the inflatable car jack remained inflated, demonstrating proper sealing and thus the fluidic diode's ability to function with a high pressure differential and to withhold a substantial volume of compressed air for extended periods. Specifically, the loss of pressure within the car jack using our fluidic diode over 10 min is only 12.7%.

### Fluidic Computing: Fundamental Logic Gates

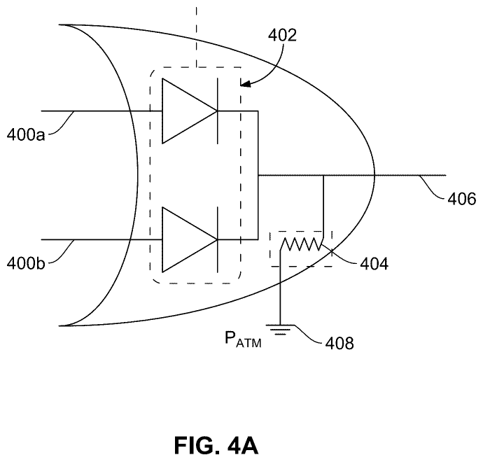

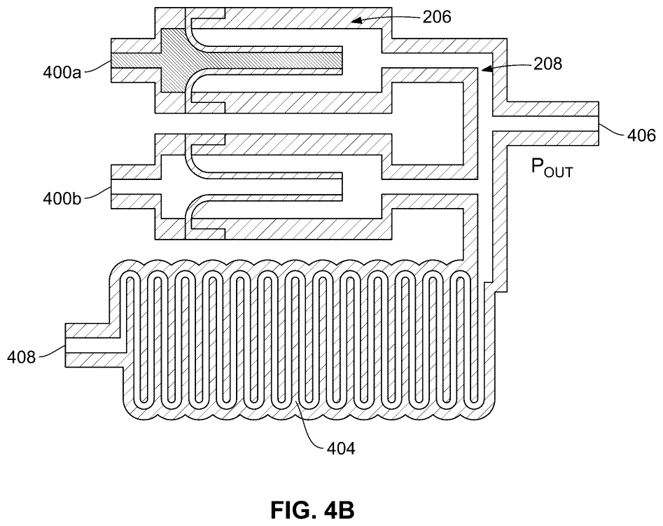

By combining two fluidic diodes in parallel connected to serpentine-shaped fluidic resistors and pressure sources, diode logic gates may be created capable of performing logical operations within soft robotic systems, opening possibilities for designing advanced fluidic systems capable of decision-making processes. FIG. 4A illustrates digital control using pneumatic diode logic gates, where two fluidic diodes 402 are configured in parallel. The placement of a serpentine-shaped fluidic resistor 404 (also called a “pull-up” resistor) connected between the output 406 and atmospheric pressure 408 (or supply pressure, not shown) allows realization of two fluidic logic gates: OR and AND, respectively. Specifically, FIG. 4A depicts an OR-gate, configured by connecting the outlet junction of the fluidic diodes 402 via a serpentine-shaped fluidic resistor 404 to atmospheric pressure 408. A first pressure input 400a and a second pressure input 400b are shown connected to the fluidic diodes 402. The same features are shown in FIG. 4B which depicts the corresponding fluidic diode.

An AND-gate (not shown) could be configured by connecting the outlet junction of the fluidic diodes 402 via a serpentine-shaped fluidic resistor 404 to a supply pressure (not shown).

The gates operate using pressure as Boolean logic levels, where ranges of pressures are assigned to binary states. The compliance of the resulting device results in small fluctuations in the output pressure. However, the binary output pressure values (P) relative to the supply pressure (PSUPP) remain within the range of 0.8≤P/PSUPP≤1 for a logical high (“1”), whereas a logical low (“0”) corresponds to pressures close to atmospheric pressure, in the range of 0≤P/PSUPP≤0.1.

Each gate is configured to receive two inputs (a first pressure input and a second pressure input) corresponding to each of the two fluidic diodes, a reference pressure connected via a pull-down or pull-up resistor to the junction of the two diode outlets, and an output pressure at this junction (pressure output). The OR-gate outputs a logical high (“1”) if either, or both, of the diodes are actuated (pressurized). In the OR-gate, the forward flow of the diodes is connected to the output and the reference pressure is connected to the pneumatic ground (atmospheric pressure, PATM) via the pull-down resistor. The pull-down resistor ensures that the output state returns to a constant low pressure rather than remaining at the supply pressure PSUPP when the inputs of the OR-gate both reside at a low pressure (“0”). The possible combinations for the OR-gate are shown in Table 1.

TABLE 1

| First pressure input | Second pressure input | Pressure output |
|---|---|---|
| 0 | 0 | 0 |
| 1 | 0 | 1 |
| 0 | 1 | 1 |
| 1 | 1 | 1 |

For the AND-gate, the forward flow is obtained from the inputs and the reference pressure is connected to a high-pressure supply (≈0.4 bar, corresponding to binary “1” in this case). With this configuration, the AND-gate outputs a logical high (“1”) if, and only if, the inlets of both diodes are actuated. For both logic gates, a thin serpentine path between sheets were used as the fluidic resistor, when pressurized it approximates a length of tubing with a radius of ≈0.55 mm (channel width of 1.75 mm for unpressurized state) to provide resistance to airflow. The possible combinations for the AND-gate are shown in Table 2.

TABLE 2

| First pressure input | Second pressure input | Pressure output |
|---|---|---|
| 0 | 0 | 0 |
| 1 | 0 | 0 |
| 0 | 1 | 0 |
| 1 | 1 | 1 |

The logic gates described in context of FIGS. 4A and 4B were fabricated using nylon taffeta. In accordance with one or more embodiments, the design of the serpentine resistor may need to be modified if a different material were selected because the fluidic resistance is dependent, in part, on the bending behavior of the constituent material. To achieve a normalized pressure approaching “1,” the fluidic resistance of the pull-down resistor in the OR-gate would need to approach infinity. However, in this limiting case, the response time for deflation would also approach infinity (and thus result in slow switching speeds), presenting an important tradeoff in system design. Meanwhile, resistance of the pull-up resistor in the AND-gate may be tuned such that the resistance is low enough to pull the output high within a suitable timeframe when both diodes are actuated but high enough to allow the output pressure to decrease to approximately atmospheric pressure for all other cases. Because logic gates are building blocks to more complex digital systems, the level to which logic gates may be cascaded—that is, combined in a sequential manner—is critical to allow construction of useful logical operations.

To build a logic circuit that tests the ability of logic gates to be cascaded, the output of a given gate was routed as the input of the successive gate for any number of gates connected in series.

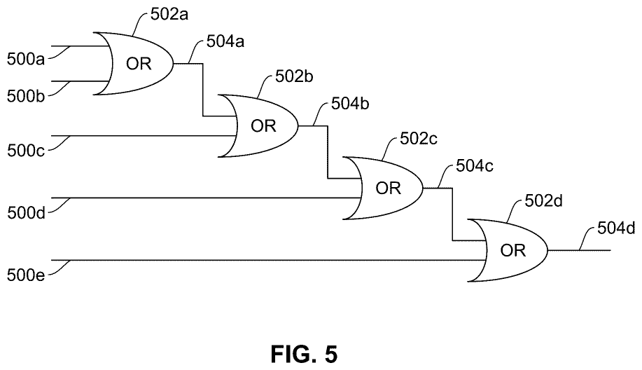

FIG. 5 depict cascaded logic gates and their performance. Specifically, FIG. 5 depicts cascaded OR-gates and their performance. Input pressure A 500a and input pressure B 500b are shown as inputs into OR-gate 502a, input pressure C 500c is shown as an input into OR-gate 502b, input pressure D 500d is shown as an input into OR-gate 502c, and input pressure E 500e is shown as an input into OR-gate 502d. Each OR-gate outputs a pressure, shown as output pressure A 504a, output pressure B 504b, output pressure C 504c, and output pressure D 504d. Cascaded AND-gates and their performance (not shown) may have a similar structure as the cascaded OR-gates shown in FIG. 5, with the same pressure inputs flowing through four AND-gates and an output pressure resulting from each AND-gate.

Table 3 shows the truth tables of the cascaded OR-gates.

TABLE 3

| | |
|---|---|
| Pressure inputs | Pressure outputs |

| A | B | C | D | E | A | B | C | D |
|---|---|---|---|---|---|---|---|---|
| 0 | 0 | 0 | 0 | 0 | 0 | 0 | 0 | 0 |
| 0 | 0 | 0 | 0 | 1 | 0 | 0 | 0 | 1 |
| 0 | 0 | 0 | 1 | 0 | 0 | 0 | 1 | 1 |
| 0 | 0 | 0 | 1 | 1 | 0 | 0 | 1 | 1 |
| 0 | 0 | 1 | 0 | 0 | 0 | 1 | 1 | 1 |
| 0 | 0 | 1 | 0 | 1 | 0 | 1 | 1 | 1 |
| 0 | 0 | 1 | 1 | 0 | 0 | 1 | 1 | 1 |
| 0 | 0 | 1 | 1 | 1 | 0 | 1 | 1 | 1 |
| 0 | 1 | 0 | 0 | 0 | 1 | 1 | 1 | 1 |
| 0 | 1 | 0 | 0 | 1 | 1 | 1 | 1 | 1 |
| 0 | 1 | 0 | 1 | 0 | 1 | 1 | 1 | 1 |
| 0 | 1 | 0 | 1 | 1 | 1 | 1 | 1 | 1 |
| 0 | 1 | 1 | 0 | 0 | 1 | 1 | 1 | 1 |
| 0 | 1 | 1 | 0 | 1 | 1 | 1 | 1 | 1 |
| 0 | 1 | 1 | 1 | 0 | 1 | 1 | 1 | 1 |
| 0 | 1 | 1 | 1 | 1 | 1 | 1 | 1 | 1 |
| 1 | 0 | 0 | 0 | 0 | 1 | 1 | 1 | 1 |
| 1 | 0 | 0 | 0 | 1 | 1 | 1 | 1 | 1 |
| 1 | 0 | 0 | 1 | 0 | 1 | 1 | 1 | 1 |
| 1 | 0 | 0 | 1 | 1 | 1 | 1 | 1 | 1 |
| 1 | 0 | 0 | 1 | 1 | 1 | 1 | 1 | 1 |
| 1 | 0 | 1 | 0 | 0 | 1 | 1 | 1 | 1 |
| 1 | 0 | 1 | 0 | 1 | 1 | 1 | 1 | 1 |
| 1 | 0 | 1 | 1 | 0 | 1 | 1 | 1 | 1 |
| 1 | 0 | 1 | 1 | 1 | 1 | 1 | 1 | 1 |
| 1 | 1 | 0 | 0 | 0 | 1 | 1 | 1 | 1 |
| 1 | 1 | 0 | 0 | 1 | 1 | 1 | 1 | 1 |
| 1 | 1 | 0 | 1 | 0 | 1 | 1 | 1 | 1 |
| 1 | 1 | 0 | 1 | 1 | 1 | 1 | 1 | 1 |
| 1 | 1 | 1 | 0 | 0 | 1 | 1 | 1 | 1 |
| 1 | 1 | 1 | 0 | 1 | 1 | 1 | 1 | 1 |
| 1 | 1 | 1 | 1 | 0 | 1 | 1 | 1 | 1 |
| 1 | 1 | 1 | 1 | 1 | 1 | 1 | 1 | 1 |

Table 4 shows the truth tables of the cascaded AND-gates, assuming the same configuration of pressure inputs and outputs as shown in FIG. 5.

TABLE 4

| | |
|---|---|
| Pressure inputs | Pressure outputs |

| A | B | C | D | E | A | B | C | D |
|---|---|---|---|---|---|---|---|---|
| 0 | 0 | 0 | 0 | 0 | 0 | 0 | 0 | 0 |
| 0 | 0 | 0 | 0 | 1 | 0 | 0 | 0 | 0 |
| 0 | 0 | 0 | 1 | 0 | 0 | 0 | 0 | 0 |
| 0 | 0 | 0 | 1 | 1 | 0 | 0 | 0 | 0 |
| 0 | 0 | 1 | 0 | 0 | 0 | 0 | 0 | 0 |
| 0 | 0 | 1 | 0 | 1 | 0 | 0 | 0 | 0 |
| 0 | 0 | 1 | 1 | 0 | 0 | 0 | 0 | 0 |
| 0 | 0 | 1 | 1 | 1 | 0 | 0 | 0 | 0 |
| 0 | 1 | 0 | 0 | 0 | 0 | 0 | 0 | 0 |
| 0 | 1 | 0 | 0 | 1 | 0 | 0 | 0 | 0 |
| 0 | 1 | 0 | 1 | 0 | 0 | 0 | 0 | 0 |
| 0 | 1 | 0 | 1 | 1 | 0 | 0 | 0 | 0 |
| 0 | 1 | 1 | 0 | 0 | 0 | 0 | 0 | 0 |
| 0 | 1 | 1 | 0 | 1 | 0 | 0 | 0 | 0 |
| 0 | 1 | 1 | 1 | 0 | 0 | 0 | 0 | 0 |
| 0 | 1 | 1 | 1 | 1 | 0 | 0 | 0 | 0 |
| 1 | 0 | 0 | 0 | 0 | 0 | 0 | 0 | 0 |
| 1 | 0 | 0 | 0 | 1 | 0 | 0 | 0 | 0 |
| 1 | 0 | 0 | 1 | 0 | 0 | 0 | 0 | 0 |
| 1 | 0 | 0 | 1 | 1 | 0 | 0 | 0 | 0 |
| 1 | 0 | 0 | 1 | 1 | 0 | 0 | 0 | 0 |
| 1 | 0 | 1 | 0 | 0 | 0 | 0 | 0 | 0 |
| 1 | 0 | 1 | 0 | 1 | 0 | 0 | 0 | 0 |
| 1 | 0 | 1 | 1 | 0 | 0 | 0 | 0 | 0 |
| 1 | 0 | 1 | 1 | 1 | 0 | 0 | 0 | 0 |
| 1 | 1 | 0 | 0 | 0 | 1 | 0 | 0 | 0 |
| 1 | 1 | 0 | 0 | 1 | 1 | 0 | 0 | 0 |
| 1 | 1 | 0 | 1 | 0 | 1 | 0 | 0 | 0 |
| 1 | 1 | 0 | 1 | 1 | 1 | 0 | 0 | 0 |
| 1 | 1 | 1 | 0 | 0 | 1 | 1 | 0 | 0 |
| 1 | 1 | 1 | 0 | 1 | 1 | 1 | 0 | 0 |
| 1 | 1 | 1 | 1 | 0 | 1 | 1 | 1 | 0 |
| 1 | 1 | 1 | 1 | 1 | 1 | 1 | 1 | 1 |

The highlighted rows of the truth tables correspond to the configurations used to experimentally measure the delays and logic level drops with each added gate connected in series, discussed further below.

To evaluate whether the cascaded arrangement of the logic gates maintained logical consistency (i.e., negligible degradation of performance and functionality), the forward signal propagation delay and the logic level drops were measured. A low signal propagation delay is important for response times, or how quickly the output reflects a change in input state, and overall coordination of signals. The forward signal propagation delay as a function of the number of gate stages was measured with OR-gates and AND-gates. 100 individual measurements were averaged to obtain each of the data points. For both the OR-gates and the AND-gates, each addition of a gate to a circuit result in an increased delay of <0.1 s, comparable to the delay of other fluidic logic gates published in the literature. Namely, the OR-gates exhibited a slope of 0.0947 seconds per additional gate and the AND-gates exhibited a slope of 0.0957 seconds per additional gate. The logical level drops where the highest pressure achieved from each additional stage is normalized by P_{max,1} (i.e., the maximum pressure output achieved by a single logic gate).

With the cascading gates, compounded fluidic resistance may cause significant pressure drops or a reduction in the signal amplitude, resulting in signal degradation. The device experienced a logic pressure drop of <2.5% per gate, for both OR-gates and AND-gates. This result indicates that additional gates do not significantly change the state of the signal when using approximately four gates in series or fewer, representing enough system complexity for memory storage, decision-making, and more.

### Fluidic Computing: Encoder Using Diode Logic

Diodes can also be used for fluidic routing by directing fluid flow along designated pathways, conduits, or channels, while preventing unwanted interactions between different input lines, ensuring that each input remains independent. To illustrate this principle, a fluidic encoder was created that outputs a 3-bit binary index for a single high (“1”) input, enabling actuation of multiple output lines (or actuators) by activating a single input line. Though a 3-bit flexible fluidic encoder is provided as an example, it will be clear to a person of ordinary skill in the art that a different number n of bits may be included in a flexible binary fluidic encoder. Accordingly, an n-bit flexible binary fluidic encoder may include a plurality n of flexible fluidic resistors.

To direct the airflow through the device, pneumatic lines were used connecting the flow between the input layer with the configured diodes and the output layer connecting to pull-down resistors and pneumatic connections that exhaust the air either to the atmosphere or to connected actuators. Although binary logic relies on two distinct logic levels, provided that the input signals are driven by a large enough pressure signal, the exact magnitude of the pressure is not critical if the output signals lie within detectably varied pressure ranges. For an input of ≈0.98 bar, the encoder outputs normalized pressure ranges of 0.8≤P/PIN≤1 for a logical high (“1”) and a logical low (“0”) between 0≤P/PIN≤0.1. Some pressure loss is expected given the increased fluidic resistance from interconnected channels and uneven pressure distribution between the pouches containing the diodes. Note that the serpentine pull-down resistors have not been optimized to decrease the system delay (i.e., the time taken for the device to fully transition from a high to low signal) or, inversely, the switching speeds with relatively shallow negative slopes of the falling edges observed in measured pressure traces. Particularly, the resistance values should allow for the internal air to exhaust into the atmosphere while not creating an overly strong bias to ground when the input is high such that the output pressures lie within a reasonable pressure range.

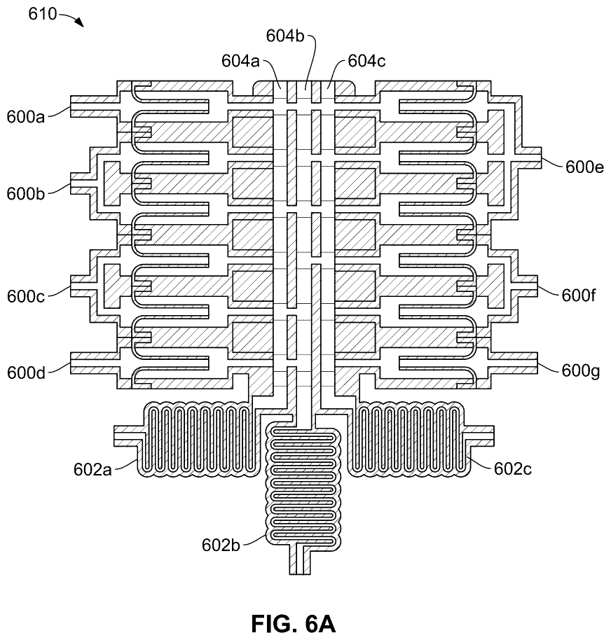

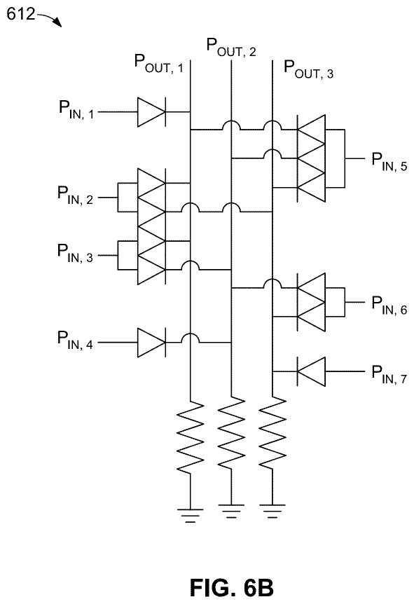

FIGS. 6A-6B illustrate a fluidic encoder in accordance with one or more embodiments. Specifically, FIG. 6A illustrates pneumatic circuit 610. 12 flexible fluidic diodes are connected to 7 input fluid conduits (pressure inputs 600a-g) on the input side and to three fluid output conduits (pressure output 604a-c) on the output side. As an example, three individual flexible fluidic diodes may each connect to a single input fluid conduit, and each connect to a single fluid output channel. As another example, three pairs of flexible fluid diodes may each connect to a single fluid input conduit and each of the two fluid output conduits coming from each pair may connect to a single fluid output channel. Additionally, one triplet of fluid dipoles may connect to a single input fluid channel and each of the three fluid output conduits originating from the triplet may connect to a different fluid output channel.

FIG. 6B is a circuit drawing 612 of pneumatic circuit 610. The pressure inputs are shown as P_{IN,1} through P_{IN,7} and the pressure outputs are shown as P_{OUt,1} through P_{OUT,3}.

Three resistors 602a-c are shown as part of the fluidic encoder. As will be clear to a person of skill in the art, many different flow pattern designs may be created by activating different pressure inputs. Table 3 is a full truth table of the fluidic encoder shown in FIGS. 6A-6B, showing examples of how different pressure inputs result in different pressure outputs. Pressure inputs 1-7 in Table 3 correspond to pressure inputs 600a-g in FIGS. 6 A-6B. Similarly, pressure outputs 1-3 in Table 3 correspond to pressure outputs 604a-c in FIGS. 6A-6B.

TABLE 5

| | Pressure inputs | | | | | | | Pressure outputs | | |
|---|---|---|---|---|---|---|---|---|---|---|
| Examples | 1 | 2 | 3 | 4 | 5 | 6 | 7 | 1 | 2 | 3 |
| A | 0 | 0 | 0 | 0 | 0 | 0 | 0 | 0 | 0 | 0 |
| B | 1 | 0 | 0 | 0 | 0 | 0 | 0 | 1 | 0 | 0 |
| C | 0 | 1 | 0 | 0 | 0 | 0 | 0 | 1 | 0 | 1 |
| D | 0 | 0 | 1 | 0 | 0 | 0 | 0 | 1 | 1 | 0 |
| E | 0 | 0 | 0 | 1 | 0 | 0 | 0 | 0 | 1 | 0 |
| F | 0 | 0 | 0 | 0 | 1 | 0 | 0 | 1 | 1 | 1 |
| G | 0 | 0 | 0 | 0 | 0 | 1 | 0 | 0 | 1 | 1 |
| H | 0 | 0 | 0 | 0 | 0 | 0 | 1 | 0 | 0 | 1 |

### Fluidic Computing: Diode Rectification

Another function of diodes is to rectify or control the flow direction during distinct phases of oscillation (i.e., to convert oscillatory fluidic input signals to direct current (DC)-like, positively phased constant fluidic signals). To demonstrate this capability, the fluidic diodes were integrated as check valves attached to a textile-based energy harvesting system. The system uses an insole device composed of a textile pouch filled with open-cell polyurethane foam that leverages its elasticity to draw atmospheric air into the pouch when the foot is lifted but is compressed during foot strike which forces pressurized air into a textile-based storage bladder to be used for powering pneumatic actuators. The textile pouch operates as a tread-activated bellows, to force air into the textile-based storage bladder.

Without the diodes, the system relied on a pair of rigid plastic check valves to enforce unidirectional flow of air, in which one valve prevents air from leaving the storage bladder during the insole's air intake phase (foot-lift) and another valve prevents air from leaving to the surrounding atmosphere from the insole as it fills the bladder during the compression phase (foot-strike). To incorporate the diodes into the system, the downstream hard plastic check valves were replaced with sheet-based fluidic diodes fabricated from nylon taffeta—the same material used for the rest of the textile-based wearable system. As for the upstream hard plastic check valve, a fluidic diode cannot be substituted due to the lack of rigidity of the textile architecture. Specifically, the walls of the sheet-based diode collapse from the negative internal pressure relative to atmospheric pressure, resulting from the expansion of the foam to its original size following foot-lift. To mitigate this issue, a hole is formed in the insole, allowing atmospheric air to enter at a faster rate. Without an additional diode, some air will escape from the insole during compression, nevertheless, the open-cell foam itself acts as a resistor with a higher resistance than the connected tubing on the bladder side, biasing the flow toward the channel connected to the diode and the bladder for storage of compressed air.

Controlled experiments were conducted mimicking a person's walking gait by using two pneumatic pistons that switch at a period of 0.5 seconds (i.e., two steps per second, consistent with walking at 4.8 km h⁻¹ by adults aged 30 and under). The experiment simulates the oscillatory output of the walking cycle, where the positive phase corresponds to the actuation of the piston (i.e., application of foot-strike) which exerts a downward, compressive force on the textile insole that pushes the captured air to the pouch, and the negative phase corresponds to the release of the piston (i.e., foot-lift) which allows the insole to expand and draw in atmospheric air. This conversion process reaches a steady state when the bladder achieves full inflation. To simulate various body weights and associated heel forces on the insole pouches, the input supply pressures to the pneumatic pistons were varied using three different supply pressures corresponding to the force from the piston that represent stepping forces of 196, 393, and 591 Newtons.

As described above, the experimental apparatus used to quantify performance of the diode rectifier for a textile-based energy harvesting system includes two pneumatic pistons (simulating the weight of a person's body), aluminum disks (simulating the heels of a person walking), and textile insoles with integrated fluidic diodes (operating as check valves). The apparatus simulated walking in a controlled environment including the textile insole used to capture and accumulate the atmospheric air in the fluidic system. Polyurethane foam in the insoles acted as resistors pneumatically connected to fluidic diodes which were connected to a 240 mL pouch that acted as a capacitor.

Output pressure traces obtained during the experiments illustrated oscillatory inputs produced from the textile insoles, with larger amplitude oscillations corresponding to higher forces from the pistons. For example, the amplitude of oscillation was found to be between approximately 20 kPa and −20 kPa under forces of 196 N, whereas the amplitude of oscillation was found to be between approximately 50 kPa and −30 kPa under forces of 591 N.

The pouch's pressure for various stepping forces averaged over three trials was found to increase then plateau as a function of time. The steady-state pressure output from the junction of the fluidic diodes was also found to increase as a function of the supply pressure (i.e., change in the maximum force pressing on the textile insole). The increasing slope shows an increase in the final pressure in the pouch (measured to fill ≈240 mL) as the supply pressure increases, for a given walking speed.

Onboard control schemes of pneumatically actuated soft robots have relied on electronic controllers and rigid, bulky electromechanical valves, imposing constraints on size and weight and undermining the benefits of soft devices and systems where compliant and adaptive characteristics are desired or necessary. Soft fluidic devices provide an alternative approach to electronic controllers that can enable complex movements and incorporate feedback based on the environment or human users. This fluidic approach reduces the overall complexity of the control systems required to generate and coordinate the actions of pneumatic actuators. Soft, fluidic diodes have been underutilized despite their significant potential in mechanical computing due to at least one of two limitations: (a) they require a minimal closing pressure to completely restrict flow in the reverse direction, or (b) they use hard materials to seal backflow or act as a physical barrier to block the flow passage, precluding seamless integration with planar or, broadly, sheet-based soft robots and resulting in a bulky, noncompact design disadvantageous for applications within tight or constrained spaces that may require the full compliance expected of soft robots.

The fluidic diode described herein has been fabricated from low-cost, flexible, sheet-based materials assembled in a layered thermal lamination process. The fluidic diode limits backflow through the passive self-pinching of a pneumatic channel connected to its inlet when the enclosing pouch of the diode is inflated. The fluidic resistance of sheet-based diodes in the forward direction is geometrically tunable to account for a range of pressures and operating conditions. Furthermore, a scaling law was developed where the fluidic resistance is inversely proportional to length scale to the third power, and the output flow rate is inversely proportional to the internal fluidic resistance. Thus, increasing the size of the diode allows for higher rates of airflow. Experimental demonstrations show that the diodes can perform within pressure ranges (0-400 kPa) and flow rates typical for most pneumatic actuators and textile wearables.

The unidirectional flow enabled by the sheet-based diode may be leveraged to realize devices with self-sealing capabilities that maintain adequate levels of pressure for real-world use, e.g., in the self-sealing balloon and inflatable car jack described herein. The diodes can also be configured to create fluidic computing elements, which are integrable in systems composed of compliant materials to regulate the flow of pressurized fluid. For example, the use of the diodes in fluidic digital logic was demonstrated, showcasing their capability of emulating the binary nature of digital systems by converting pneumatic inputs into digital signals or binary states defined by two distinct pressure ranges for control and computation. Specifically, logic gates that perform Boolean operations, i.e., OR and AND operators, were constructed allowing for simple decision-making processes. The diode logic gates do not yield functionally complete digital logic systems because the output is in the same phase as the input; consequently, the pneumatic signal cannot be inverted, and a NOT gate cannot be constructed. However, a sheet-based inverter (equivalent to a NOT gate) may be combined with the diode logic gates for a functionally complete set of logical connectives, leading to more complex logic functions. Despite the lack of functional completeness when using diodes alone, in contrast to AND and OR logic gates created using transistor-like elements (i.e., transistor-resistor logic) which require the use of three fundamental fluidic elements (transistors), the diode logic gates shown in this work use fewer fluidic elements and interconnections, consequently offering a more compact approach.

Furthermore, the tunable diode logic gates can be composed in a cascading manner with comparable performance to conventional counterpars, suggesting that diode logic gates can be used in a computing architecture in combination with other sheet-based fluidic analogs to electronic components. A 3-bit fluidic encoder was developed composed entirely of diodes to map a single input to a combination of output lines, enabling the actuation of multiple actuators. The ability of the diodes to respond to analog signals was also demonstrated by using them as check valves in an energy harvesting system that converted oscillating input pressures to a positive-phased output pressure that is then captured in a textile-based bladder acting as a pneumatic capacitor. Though the overall system volume, which is increased with additional tubing, valves, and other components to regulate the airflow, may represent a limitation for fluidic diodes compared to electronic controllers, the durability of these systems has been shown to surpass electronic counterparts in wearable applications. Additionally, fluidic control is suitable for many low-level controllers, including in tandem with electronic systems.

The fluidic diodes disclosed herein may be regarded as fundamental components in future development of sheet-based logic controllers, including embedded textile-logic systems for soft wearables and pneumatic assistive devices or soft robots with on-demand collapsibility for ease of deployment, like origami-inspired soft robots. The 2D architecture of these diodes also allows them to be combined with other sheet-based fluidic devices in a monolithic architecture to create modular, advanced integrated circuits. For example, computing devices, actuators, and sensing components that can directly interface with each other may be integrated into soft robotic systems that are programmable and reactive to the environment.

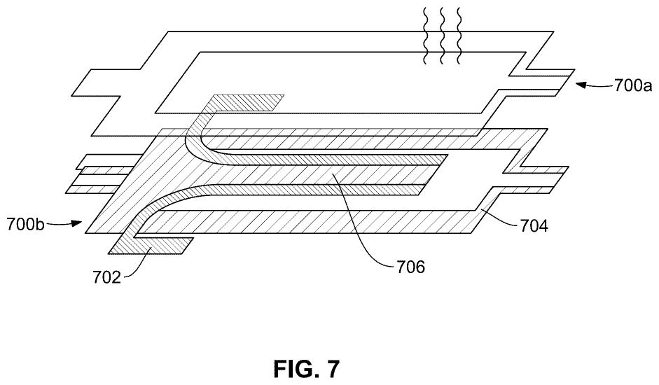

FIG. 7 depicts the fabrication of the fluidic diode in accordance with one or more embodiments. The fabrication process of a fluidic diode may begin with stacked layers of heat-sealable sheet materials including nylon taffeta with TPU coated on one side and an adhesive-backed paper transfer tape. A vinyl cutter may be used to cut the layer in two passes. The first pass patterns the internal geometries on the top layer (i.e., paper transfer tape with the adhesive on the TPU-coated side of the nylon taffeta) and is followed by a deeper cut outlining the perimeter of the component. Extraneous materials are weeded (i.e., removed) to define the bonding regions. The resulting layers are shown in FIG. 7. Specifically, the upper layer 700a is shown with the nylon taffeta facing away from the lower layer 700b. The lower layer 700b is shown with TPU-coated nylon taffeta 702 and paper transfer tape 704 defining a fluidic diode 706. To form the fluidic diode, the textile layers are heat-pressed together. For example, a heat press may be heated to 185° C. and exert a force of 300 kPa for 30 seconds on the layers shown in FIG. 7. Pneumatic connectors (e.g., a dispensing needle with Luer lock connections, a barb-to-barb fitting, a barb-to-Luer lock connection, non-barbed adapter) may then be epoxied to the inlets of the fluidic diode.

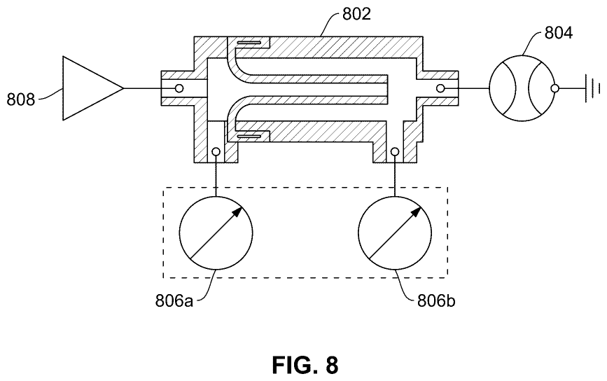

FIG. 8 displays a characterization of the forward flow across the inner valve of the fluidic diode. Specifically, FIG. 8 displays a schematic of the electropneumatic circuit for static pressure measurements of various isometrically scaled diodes. A pressure supply 808 is shown fluidly connected to a fluidic diode 802 and flowmeter 804. Additional ports 806a and 806b may be used to characterize the fluidic resistance across the inner duckbill-like valve in the fluidic diode 802, for example, using pressure sensors. Additionally, the flowmeter 804 may be electrically connected to an electric source, such as a 5-volt outlet.

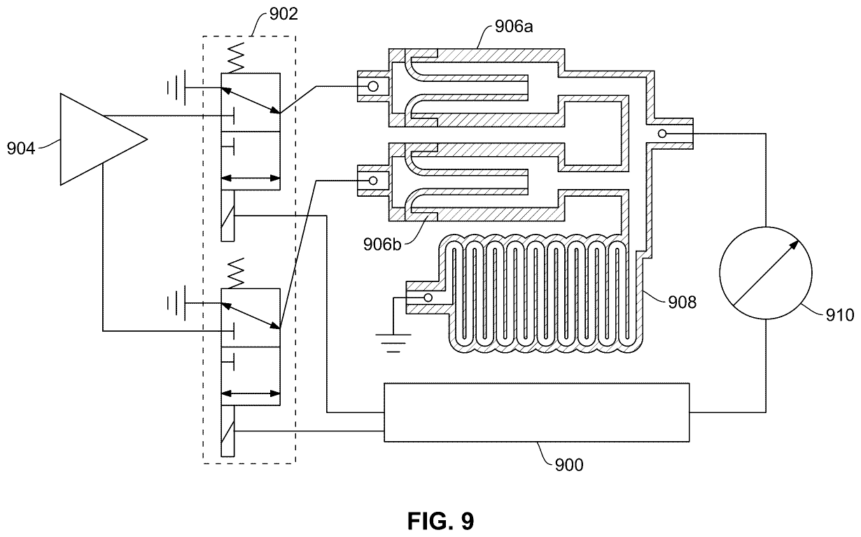

FIG. 9 depicts a schematic of an electropneumatic circuit used to experimentally obtain the transient response of logic gates. A pulsed digital signal from a data acquisition module 900 was used to control the pneumatic solenoid valves 902 connected to a ˜40-kPa compressed air supply 904 which generates square-wave inputs by switching between the supply pressure and atmospheric pressure to obtain the input and output pressure traces of the logic gates in fluidic diodes 906a and 906b. OR-gates are shown in FIG. 9, though the OR-gates could be replaced with AND-gate in accordance with one or more embodiments. A resistor 908 and pressure sensor 910 are also shown.

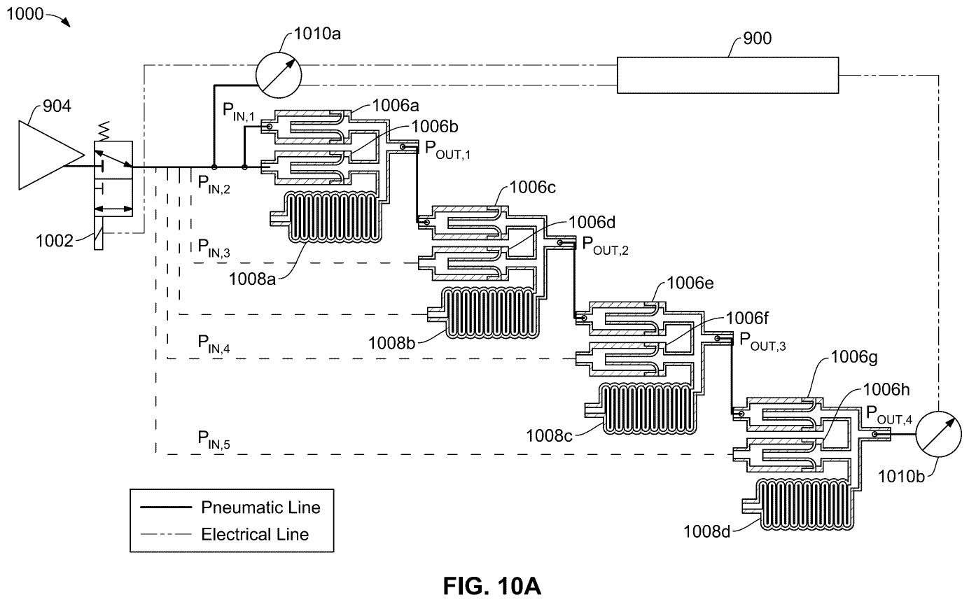

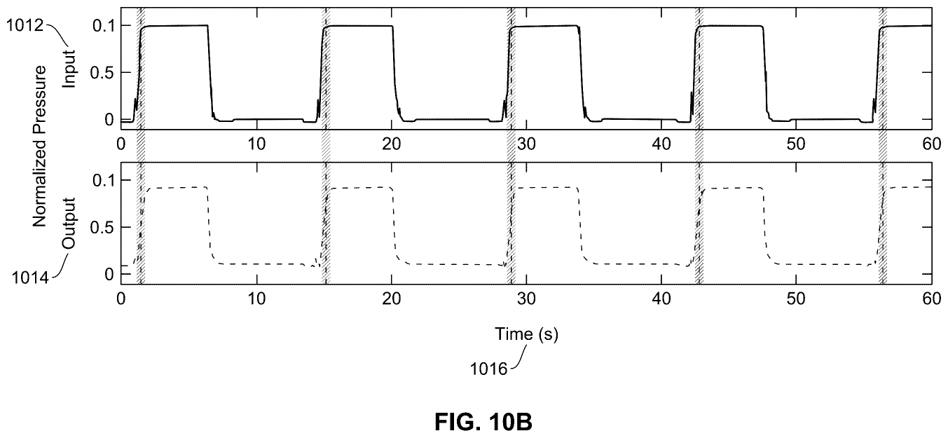

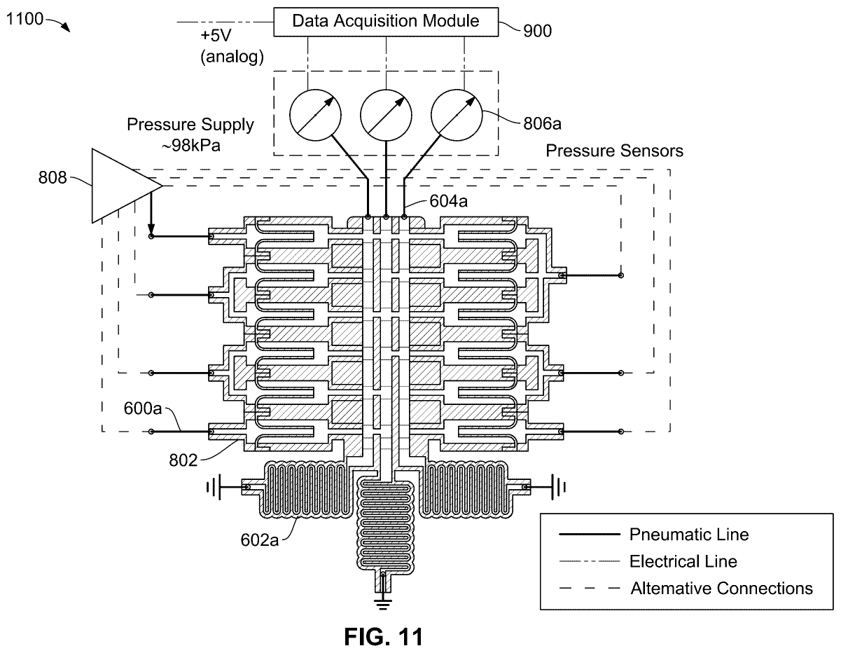

FIGS. 10A-10B depict the performance of cascading AND-gates. FIG. 10A shows a schematic of electropneumatic circuit 1000 used to experimentally obtain the forward delay measurements and pressure drops of each logic gate. FIG. 10A includes many of the same features as FIG. 9, such as ˜40-kPa compressed air supply 904, solenoid valve 1002, and data acquisition module 900. FIG. 10A also includes pressure sensors 1010a-b, resistors 1008a-d, and fluidic diodes 1006a-h. A solid line in FIG. 10A represents the main pneumatic line, i.e., pressure input (P_{in,1}) to the first logic gate which feeds into the input of subsequent logic gates. A chain double dashed line in FIG. 10A represents an electrical line. Dashed lines in FIG. 10A represent pressure inputs (P_{in,2}, P_{in,3}, etc.) to subsequent logic gates.

Table 6 shows the pressure inputs that are high (i.e., the pneumatic solenoid valve switch to supply pressure) for each configuration with different number of n cascaded logic gates.

TABLE 6

| | |
|---|---|
| Pressure inputs | Pressure outputs |

| n | 1 | 2 | 3 | 4 | 5 | 1 | 2 | 3 | 4 |
|---|---|---|---|---|---|---|---|---|---|
| 1 | 1 | 1 | 0 | 0 | 0 | 1 | 0 | 0 | 0 |
| 2 | 1 | 1 | 1 | 0 | 0 | 1 | 1 | 0 | 0 |
| 3 | 1 | 1 | 1 | 1 | 0 | 1 | 1 | 1 | 0 |
| 4 | 1 | 1 | 1 | 1 | 1 | 1 | 1 | 1 | 1 |

FIG. 10B shows an example of measured normalized pressure input 1012 and normalized pressure output 1014 for a 4-gate cascaded network, such as the one shown in FIG. 10A. The normalized pressure values are plotted over time 1016. The forward propagation delay is the time delay between the leading edges of the input and output signals (referenced from the points where the normalized signals cross above or below 0.5). The logic pressure drop is the ratio between the highest measured input pressure and the highest measured output pressure.

FIG. 11 shows a schematic of an electropneumatic circuit 1100 for characterization of the 3-bit encoder. FIG. 11 may incorporate pneumatic circuit 610, including pressure inputs (e.g., pressure input 600a), pressure outputs (e.g., pressure output 604a), and resistors (e.g., resistor 602a). FIG. 11 may also include a pressure supply 808, a port for a pressure sensor (e.g., port 806a), and fluidic diodes (e.g., fluidic diode 802). Specifically, FIG. 11 shows the input signal generated by switching on the pressure supply 808 connected to a ˜98-kPa compressed air supply for approximately 10 seconds and then switching off (i.e., connecting the input to atmospheric pressure). The fluidic diodes such as fluidic diode 802 isolate the pressure input lines resulting in an encoding circuit where the output signals (and thus the desired states of multiple actuators) are controlled by a single set of inputs.

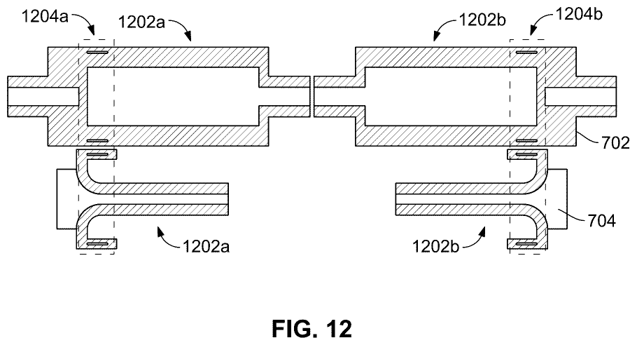

FIG. 12 depicts preparation of textile layers used for layered fabrication of a fluidic logic gate. Each gate contains two fluidic diodes, such as fluidic diodes 1200a and 1200b, that are layered between pouches 1202a and 1202b. Alignment slits 1204a and 1204b are used to align the fluidic diodes 1200a and 1200b with the pouches 1202a and 1202b. As described in context of FIG. 7, the textile layers are made from TPU-coated nylon taffeta 702 coated with TPU on one side. Paper transfer tape 704 is used to keep certain layers from melding together when exposed to heat.

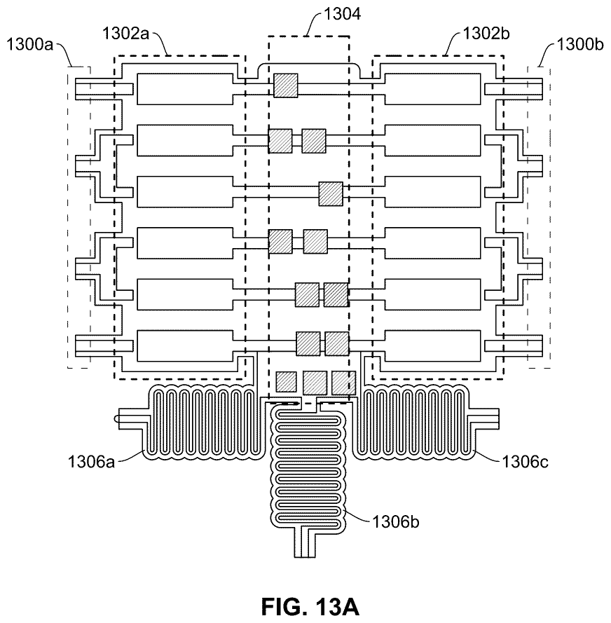

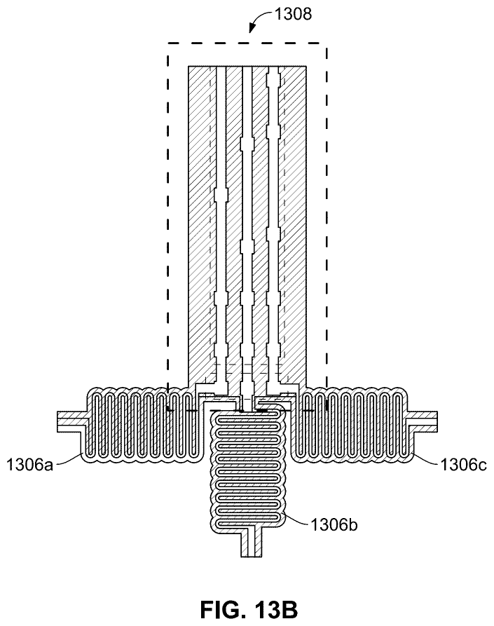

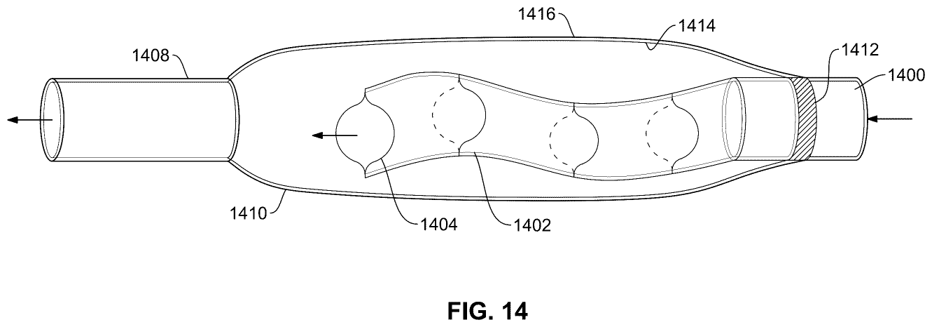

FIGS. 13A-B depict preparation of textile layers used for layered fabrication of 3-bit encoder. FIG. 13A shows the bottom layer of the encoder which includes the pouches 1302a-b encasing the fluidic diodes, connections to the pneumatic vias 1304 on the output channel layer, and the serpentine-path pull-down resistors 1306a-c to exhaust air from the output channel when the input signal is switched to low. The 3-bit encoder requires 12 fluidic diodes sandwiched between the empty pouches 1302a-b of layers. The rounded square holes form the pneumatic vias 1304 that connects the input and output channel layers. Additionally, pressure inputs 1300a-b are shown fluidly connected to the pouches 1302a-b. The top layer of the input channel of the 3-bit encoder is a mirror image of the pressure inputs, 1300a-b, pouches 1302a-b, and pneumatic vias 1304 shown in FIG. 13A. Air may flow between the input and output channel layers (i.e., through a channel between the layers) of the 3-bit encoder. A channel is shown in FIG. 14 to illustrate the air flow between the input and output channel layers.

FIG. 13B depicts the output channel layer of the 3-bit encoder that includes the output channels 1308 and the serpentine-path pull-down resistors 1306a-c to exhaust air when the input signal is switched to low (otherwise the output signal will stay high as a floating value). The output channels 1308 potentially connect to pneumatic actuators using pneumatic connectors. Additionally, the output channels may include vias, such as pneumatic vias 1304, in accordance with one or more embodiments.

In accordance with one or more embodiments, the geometric design of the fluidic resistors used in the logic gates may be designed as long, thin serpentine-path channels with a constant channel width W and a gap of D. For example, the channel width may be 1.5 mm and the channel gap may be 1.5 mm. By increasing the number of lines, N, fluidic resistors of various resistances can be achieved because an increase in path length increases resistance. The number of lines, N, was determined empirically to achieve different desired responses consistent with OR-gates and AND-gates depending on the number of lines included. For example, N=9 was found to result in an OR-gate and N=10 was found to result in an AND-gate.

### Fabrication of Textile Fluidic Diode and Logic Devices

To fabricate the fluidic diode and logic devices disclosed herein, an adhesive paper tape (such as V0821, Vinyl Ease, etc.) may be applied to mask the TPU-coated side of heat-sealable nylon taffeta fabric (such as Riverseal 70 LW, Rivertex Technical Fabrics Group, etc.). The masked side may then be patterned using a desktop vinyl cutter (e.g., Maker, Cricut, etc.) that forms the internal geometries and pathways for airflow within the device; the outlines of the paper mask were engraved using the “Washi Tape” setting at “low pressure” while cuts through the textile layer were made using “Copy Paper” setting at “high pressure.” After weeding the extraneous areas of the mask, the layers may be stacked, vertically aligned, and thermally bonded using a benchtop heat press (e.g., DK20SP, Geo Knight & Co Inc.) at 180° C. and 35 kPa platen pressure for a duration of 30 s. Pressing the device may be advantageous as it cools to ensure a strong bond of the heat-sealable textiles and prevent wrinkles. Finally, pneumatic ports (such as stainless steel dispensing needle with Luer lock connection; 75165A272, McMaster-Carr) were attached to the heat-sealed device using two-part epoxy glue (e.g., clear epoxy, Gorilla Inc.) to create airtight joints. Pneumatic connections between the pressure supply source and pneumatic polyurethane connections were all wired using flexible polyurethane tubing (e.g., 3/3200 inside diameter; 5648K231, McMaster-Carr).

### Characterization and Pneumatic Testing of Fluidic Devices

The pressure inputs of the fluidic diodes and logic devices may be supplied from a compressed air line fed to a pressure regulating valve (e.g., PR364, Parker Hannifin Corporation). The input of the diode was connected to the compressed air supply and the input pressure was linearly increased from 0 kPa at intervals of 50 kPa until a flow rate of approximately 5 L min⁻¹ is achieved, the maximum rated flow rate of the connecting flowmeter at the outlet of the diode. With each interval, static pressure measurements were obtained at steady state using digital pneumatic pressure gauges (e.g., MG1-30-A-9V-R, SSI Technologies Inc.). For transient measurements, such as the logic gates and rectifier, input and output pressure signals may be measured using electronic pressure sensors (e.g., ADP5151, Panasonic Corporation) connected to an analog voltage acquisition device (e.g., USB-6002, National Instruments). For logic gates, the square-wave input signals may be generated by first setting the supply pressure with a manual pressure regulator at 40 kPa and then splitting the lines through pneumatic solenoid valves (e.g., VT307-5DZ1-02N-F) using a tee-connector (e.g., 51525K445, McMaster-Carr) connected at the inlet of each diode. As for the reference pressures connected to the resistors, the port of the OR-gate is open to atmospheric air for a pull-down resistor and the port of the AND-gate is connected to the supply pressure line using another tee-connector. The valve was then switched between the supply and exhaust pressures using pulsed digital output from a data acquisition device (e.g., USB-6210, National Instruments). Each combination of inputs represented in the truth table was demonstrated by supplying an input signal for 10 s with a 5 s pause in-between to allow the system to reset (i.e., exhaust pressurized air in the device to the atmosphere). For the encoder, each of the seven inputs was connected to a 100-kPa compressed air supply that is switched on and off by a single-action air directional control valve (e.g., 62475K14, McMaster-Carr) connected to a manifold (e.g., 5469K101, McMaster-Carr). The square-wave inputs were timed for a period of approximately 10 s. Pressure traces were recorded from the data acquisition device interfaced to a computer, and the collected data were processed using custom scripts in MATLAB (e.g., version R2022a, MathWorks Inc.).

### Fabrication and Testing of Self-Sealing Balloon

For fabrication of the self-sealing balloon, an existing mylar balloon (e.g., B098FC99FM, KatchOn) may be modified by cutting a section of the top, to epoxy a plastic tube plug (e.g., 51525K271, McMaster-Carr) connected to a plastic cap (e.g., 51525K245, McMaster-Carr) to exhaust the helium, and the bottom, to insert the diode valve. To create the sheet diode, a similar technique of vector cutting and stacked heat sealing may be used where the perimeter of the device is cut from thin TPU film (e.g., Stretchlon 800, Airtech International Inc.) and the internal volumes of the device are defined by sealing layers with a thicker TPU film (e.g., Riverseal Film T150 87A, Rivertex Technical Fabrics Group) to create an airtight seal around the edges. The geometry of the inlet of the nylon fluidic diode in the forward direction may be designed to be retrofitted to the nozzle of the helium tank (e.g., B01M0PG5BD, BalloonTime). For the testing of the balloon, a flexible polyurethane tube (6516T62, McMaster-Carr) may be connected to a Luer lock connection (e.g., 51525K12, McMaster-Carr) with a dispensing needle (e.g., 75165A249, McMaster-Carr) then inserted into the inlet of the flexible diode. Helium may be released to the balloon from the tank by compressing the nozzle. Once inflated, the balloon can be deflated by disconnecting the plastic cap to exhaust the helium to the environment.

### Modification of Inflatable Car Jack

For the demonstration, a custom adapter may be attached to the inlet of a commercially available inflatable car jack (e.g., B092ML7TMC, Wayska) with the hexagonal end of the barbed tube fitting epoxied to the open center (e.g., 5058K826, McMaster-Carr). The fitting may be connected to a quick-disconnect coupling (e.g., ¼ 00 NPT and ⅜ 00 Pipe Size; 5602K25, McMaster-Carr) connected to the fluidic diode fabricated from nylon taffeta and connected to another quick-disconnect coupling (e.g., ¼ 00 NPT and ⅜ 00 Pipe Size; 6534K27 and 1077T18, McMaster-Carr). The inlets of the diodes may be further reinforced by epoxying 1 inches long PVC plastic tubing (e.g., % in ID; 5238K748, McMaster-Carr) to prevent kinking during inflation. Connection of the tube to the textile was further clamped using hose clamps (e.g., 5415K15, McMaster-Carr). The adapter may be 3D printed using a fused-deposition modeling printer (e.g., Creality CR-10S Pro) and G-code was generated using slicing software with parameters and printing settings following standard quality (0.8 mm wall thickness, printing temperature of 215° C., and build plate temperature of 60° C.). To inflate, the car jack may be initially supplied with 20 psi and slowly increased the pressure to 60 psi via an air compressor (B00UHNM1R0, Bostitch) with the given hose connected to the adapter.

### Experimental Setup and Pneumatic Testing of Diode Rectification

The textile insoles were fabricated with pouch volume of approximately 35 mL. The design of the textile may be modified with an additional port which allows a small opening where the foam is exposed to the atmosphere to circumvent the negative pressure problem described earlier in this work, and another port may be connected to flexible rubber tubing (e.g., 9776TI, McMaster-Carr) with pneumatic connectors. To create the apparatus that will simulate the walking gate, a mechanofluidic system may be assembled that uses round-body air cylinders (e.g., 1½ in Bore, 1 Inch Stroke; 6498K211, McMaster-Carr) actuated by supplying compressed air at three different pressures to represent the different magnitudes of step forces varied by a person's weight: 25, 50, and 75 kPa. The air cylinders may be secured to T-slotted frames which are then secured to a plate with brackets. The ends of the cylinders have aluminum disk contact pads that represent the area of the heel when pressed upon the textile insole pouches (e.g., 2 in diameter; 1610T15, McMaster-Carr). A hole is tapped into the aluminum using a steel general purpose tap (e.g., 1 7/16 in thread length, McMaster-Carr) allowing the aluminum plate to be screwed to the nose of the air cylinders. The periodic compression and release of the textile insoles were controlled by oscillatory square-wave pressure signals generated by solenoid valves controlled by an electronic computer as previously described.

### Characterizing Fluidic Resistance of Diodes

Analogous to electronic devices for which the Ohmic resistance is the slope of the voltage versus current curve, the slope of the pressure versus volumetric flow rate curve is equivalent to the fluidic resistance of an “Ohmic” fluidic device. To relate the differential pressure across the fluidic diode and the volumetric flow rate passing through the diode to each other as a function of the geometric parameters of the diode, the Hagen-Poiseuille equations (Eqs. 1-2) were applied. The resulting model assumes the nylon taffeta is inextensible (i.e., the actuator inflates starting from a flat, 2D geometry to an expanded, 3D geometry but the sheet material itself does not stretch—it only bends). For a diode, the forward direction is defined as the direction with the least resistance to flow. For our design of the fluidic diode, the forward direction corresponds to flow entering the inlet connected to the duckbill-like channel. To obtain the steady state pressure measurements (i.e., PIN and POUT), digital pneumatic pressure gauges (MG1-30-A-9V-R, SSI Technologies Inc.) were used. For the flowrate Q, the output pneumatic port may be connected to a flowmeter (FLR1006-D Flo-Sensor, Omega Engineering). In the deflated state of the fluidic diode, the width of the channel of the inner valve is w. For the inflated state of the fluidic diode, the cross-section approximated as a circle, with a diameter D estimated as 2wh/π:

$$Δ P = POUT - PIN = 8 μ L Q / π r 4 \qquad Eq . ( 1 )$$

$$P / Q = 8 μ Q / π r 4. \qquad Eq . ( 2 )$$

Furthermore, the flowing air must be within the laminar regime to characterize fluidic resistance of the flowing air across the duckbill from a linear slope on a plot of A P vs. Q (turbulent flow typically has a non-linear ΔP vs. Q relationship). To verify that the flow was laminar, the Reynolds number was calculated assuming the pressurized flowing fluid is compressed air at 25° C. with a density of ρ=1.184 kg L⁻¹ and dynamic viscosity of μ=1.849×10-5 kg m⁻¹ s⁻¹

In the system, the Reynolds number was approximated using Eqs. 3-6 where Q is the volumetric flow rate and r is the radius of the circular cross-sectional area of the valve when inflated in the forward direction (equivalent to r=D/2, the diameter). When testing the device, the flow rate never exceeded 5 L min⁻¹, corresponding to a Reynolds number of 3537, ˜1.5 times the transition value of 2300 (i.e., the approximate maximum Reynolds number for flow in the laminar regime). However, this number is made with the assumption of a perfectly circular cross-sectional area, whereas the cross-sectional area of the inflated internal channel is likely closer to a pointed ellipse where the bonded edge of the valve pinches as the internal channel expands.

Thus, a higher calculated Reynolds number is reasonable as the cross-sectional area of a circle is always greater than the cross-sectional area of an ellipse for the same given perimeter.

$$Re = ρ VD / μ \qquad Eq . ( 3 )$$

$$V = Q / A \qquad Eq . ( 4 )$$

$$V = π {D}^{2} / 4 , D = 2 r \qquad Eq . ( 5 )$$

$$Re = 2 ρ Q / μ π r . \qquad Eq . ( 6 )$$

### Fabricating “Self-Tying” Balloons

To fabricate the “self-tying” (i.e., self-sealing due to the incorporation of a sheet-based fluidic diode) balloon, an existing mylar balloon (such as B098FC99FM, KatchOn) may be modified by adding ports at the top and bottom to exhaust the helium and to attach the diode valve, respectively. The minimum radius required for the balloon to float by may be determined comparing the gravitational force (i.e., weight of the balloon and the helium inside) and the buoyant force (i.e., weight of the displaced air). The force balance equations, may be given as:

$${F}_{B , helium} = {F}_{G , ballon} . \qquad Eq . ( 7 )$$

$${ρ}_{air} {V}_{sphere} g = {m}_{b a l l o o n} g + {ρ}_{helium} {V}_{sphere} \cdot g \qquad Eq . ( 8 )$$

$${V}_{sphere} = 4 π {r}^{3} . \qquad Eq . ( 9 )$$

$$S = 4 π {r}^{2} \qquad Eq . ( 10 )$$

$${m}_{balloon} = {ρ}_{mylar} S . \qquad Eq . ( 11 )$$

Assume the balloon is surrounded by atmospheric air at 25° C. with a density of ρₐᵢᵣ=1.29 kg/L and the balloon is filled with helium of density βₕₑₗᵢᵤₘ=0.178 kg/L. For a mylar balloon, the mylar sheet density was experimentally determined as ρ_{mylar}=0.0337 kg/m² by weighing a 60-by-60-cm square of mylar (measured to be 12.3 g) and dividing it by the sheet area of 3600 cm². With the minimum radius required multiplied by a safety factor (to account for additional mass of pneumatic connections, fluidic diode, and seam allowance), the radius of the balloon can be calculated using Eq. 10.

To create the sheet-based diode, the technique of vinyl cutting and stacked heat sealing was used where the perimeter of the device is cut from thin TPU film (e.g., Stretchlon 800, Airtech International Inc.) and the internal geometry of the device is defined by sealing layers with a thicker TPU film (e.g., Riverseal Film T150 87A, Rivertex Technical Fabrics Group) to create an airtight seal around the edges. The layers are stacked using a benchtop heat press (e.g., DK20SP, Geo Knight & Co Inc.) at 160° C. and 25-kPa platen pressure for a duration of 20 s. The geometry of the inlet of the nylon fluidic diode in the forward direction is designed to be custom fitted to the nozzle of a helium tank (e.g., B01M0PG5BD, BalloonTime). The fluidic diode may then be attached to the mylar by placing the pneumatic outlet of the diode between the layers of the inlet of the mylar balloon and heat pressing the layers using a benchtop heat press at 160° C. To selectively heat only the section of the balloon where the TPU film contacts the mylar, additional layers of construction paper may be stacked for thermal insulation in the regions which were not designed to be heat pressed.

For testing the balloon, a flexible polyurethane tube (e.g., 6516T62, McMaster-Carr) was connected to a Luer lock connection (e.g., 51525K12, McMaster-Carr) with a dispensing needle (e.g., 75165A249, McMaster-Carr) inserted into the inlet of the flexible diode. The balloon may be filled with helium from the tank by opening the nozzle. Once inflated, the balloon can be deflated by opening the exhaust port to vent helium to the environment.

FIG. 14 depicts a flexible fluidic diode, in accordance with one or more embodiments. The flexible fluidic diode includes a first deformable conduit 1400 that terminates at one end with a passive self-pinching fluidic channel 1402 having an unsealed free end at a first end 1404; and terminates with a first connecting port at a second, opposing, end. The flexible fluidic diode further includes a second deformable conduit 1408, including an inflatable fluidic channel 1410 with a sealing end, configured to enclose at least a portion of the passive self-pinching fluidic channel and to form a seal 1412 between an inner surface of the inflatable fluidic channel 1414 and an outer surface 1416 of the passive self-pinching fluidic channel 1402. The first deformable conduit contains a fluid at a first pressure, and the second deformable conduit contains the fluid at a second pressure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. An apparatus, comprising:
a first deformable conduit, comprising a passive self-pinching fluidic channel having an unsealed free first end; and
a second deformable conduit, comprising an inflatable fluidic channel with a sealing first end, configured to enclose at least a portion of the passive self-pinching fluidic channel and to form a seal between an inner surface of the inflatable fluidic channel and an outer surface of the passive self-pinching fluidic channel,
wherein the first deformable conduit contains a fluid at a first pressure, and the second deformable conduit contains the fluid at a second pressure.

2. The apparatus of claim 1, wherein the apparatus further comprises:
a first connecting port at a second end of the first deformable conduit, and
a second connecting port at a second end of the second deformable conduit,
wherein the first connecting port and the second connecting port comprise pneumatic connectors.

3. The apparatus of claim 1, wherein the second deformable conduit, comprises:
a first hermetically sealable textile sheet; and
a second hermetically sealable textile sheet, wherein each of two opposing edges of the first hermetically sealable textile sheet is hermetically sealed to one of two opposing edges of the second hermetically sealable textile sheet.

4. The apparatus of claim 3, wherein the first hermetically sealable textile sheet and the second hermetically sealable textile sheet comprise a thermoplastic-coated textile.

5. The apparatus of claim 1, wherein the passive self-pinching fluidic channel having the unsealed free first end is configured to collapse forming a seal when the second pressure is greater than the first pressure.

6. The apparatus of claim 1, wherein the passive self-pinching fluidic channel having the unsealed free first end is configured to flow the fluid from the passive self-pinching fluidic channel into the second deformable conduit when the first pressure is greater than the second pressure.

7. The apparatus of claim 1, wherein the fluid comprises a carbon dioxide gas.

8. The apparatus of claim 1, further comprising:
a tread-activated bellows comprising an output fluid channel; and
a textile storage pouch comprising an input channel,
wherein the output fluid channel of the tread-activated bellows is connected to the second end of the first deformable conduit, and the input channel of the textile storage pouch is connected to the second connecting port of the second deformable conduit.

9. A flexible fluidic logic gate, comprising:
a plurality of flexible fluidic diodes, wherein each of the plurality comprises:
a first deformable conduit, comprising a passive self-pinching fluidic channel having an unsealed free first end; and
a second deformable conduit, comprising an inflatable fluidic channel with a sealing end, configured to enclose at least a portion of the passive self-pinching fluidic channel and to form a seal between an inner surface of the inflatable fluidic channel and an outer surface of the passive self-pinching fluidic channel,
wherein the first deformable conduit contains a fluid at a first pressure, and the second deformable conduit contains the fluid at a second pressure; and
at least one flexible fluidic resistor.

10. The flexible fluidic logic gate of claim 9, wherein the plurality of flexible fluidic diodes and the at least one flexible fluidic resistor are configured to form a logical OR-gate.

11. The flexible fluidic logic gate of claim 9, wherein the plurality of flexible fluidic diodes and the at least one flexible fluidic resistor are configured to form a logical AND-gate.

12. The flexible fluidic logic gate of claim 9, wherein the second deformable conduit, comprises:
a first hermetically sealable textile sheet; and
a second hermetically sealable textile sheet, wherein each of two opposing edges of the first hermetically sealable textile sheet is hermetically sealed to one of two opposing edges of the second hermetically sealable textile sheet.

13. The flexible fluidic logic gate of claim 12, wherein the first hermetically sealable textile sheet and the second hermetically sealable textile sheet comprise a thermoplastic-coated textile.

14. The flexible fluidic logic gate of claim 9, wherein the passive self-pinching fluidic channel having the unsealed free first end is configured to collapse forming a seal when the second pressure is greater than the first pressure.

15. The flexible fluidic logic gate of claim 9, wherein at least one flexible fluidic resistor comprises a thin serpentine-path channel.

16. A flexible binary fluidic encoder comprising the flexible fluidic logic gate of claim 9.

17. The flexible binary fluidic encoder of claim 16, wherein the flexible fluidic logic gate comprises a plurality n of flexible fluidic resistors comprising the at least one flexible fluidic resistor, wherein the flexible binary fluidic encoder is an n-bit flexible binary fluidic encoder.

18. The flexible binary fluidic encoder of claim 17, wherein n is 3, and the flexible fluidic encoder comprises:
three individual flexible fluidic diodes, wherein each of the three individual flexible fluidic diodes are connected to one input fluid conduit;
three pairs of flexible fluidic diodes, wherein each of the three pairs of flexible fluidic diodes are connected to one input fluid conduit;
one triplet of flexible fluidic diodes, wherein the triplet of flexible fluidic diodes is connected to one input fluid conduit; and
three fluidic resistors,
wherein a first fluidic resistor is connected to a first fluid conduit, a second fluidic resistor is connected to a second fluid conduit, and a third fluidic resistor is connected to a third fluid conduit, and
wherein an output of a first individual flexible fluidic diode is connected to the first fluid conduit, an output of a second individual flexible fluidic diode is connected to the second fluid conduit, an output of a third individual flexible fluidic diode is connected to the third fluid conduit, a first output of a first pair of flexible fluidic diodes is connected to the first fluid output conduit, a second output of the first pair of flexible fluidic diodes is connected to the third fluid output conduit, a first output of a second pair of flexible fluidic diodes is connected to the first fluid output conduit, a second output of the second pair of flexible fluidic diodes is connected to the second fluid output conduit, a first output of a third pair of flexible fluidic diodes is connected to the second fluid output conduit, and a second output of the third pair of flexible fluidic diodes is connected to the third fluid output conduit, and
wherein a first output of the triplet of flexible fluidic diodes is connected to the first output conduit, a second output of the triplet of flexible fluidic diodes is connected to the second output conduit, and a third output of the triplet of flexible fluidic diodes is connected to the third output conduit.

19. The flexible 3-bit fluidic encoder of claim 16, wherein each fluidic diode comprises:
a first deformable conduit, comprising a passive self-pinching fluidic channel having an unsealed free first end and a first connecting port at a second end of the first deformable conduit; and
a second deformable conduit, comprising an inflatable fluidic channel with a sealing first end, configured to enclose at least a portion of the passive self-pinching fluidic channel and to form a seal between an inner surface of the inflatable fluidic channel and an outer surface of the passive self-pinching fluidic channel, and a second connecting port at a second end of the second deformable conduit,
wherein the first deformable conduit contains a fluid at a first pressure, and the second deformable conduit contains the fluid at a second pressure.

20. The flexible 3-bit fluidic encoder of claim 17, wherein the passive self-pinching fluidic channel having the unsealed free first end is configured to collapse forming a seal when the second pressure is greater than the first pressure.
